(19) United States
(12) Patent Application Publication
(10) Pub. No.: US 2014/0136290 A1
(43) Pub. Date: May 15, 2014

(54) VENDOR MANAGEMENT AND MAINTENANCE SYSTEM

(71) Applicant: TARGET BRANDS, INC., Minneapolis, MN (US)

(72) Inventors: Brent Peter Schiestl, Brooklyn Park, MN (US); John Donald Somrock, Savage, MN (US); Liju Chelamattathil Paul, Brooklyn Park, MN (US)

(73) Assignee: TARGET BRANDS, INC., Minneapolis, MN (US)

(21) Appl. No.: 13/673,129

(22) Filed: Nov. 9, 2012

(51) Int. Cl. G06Q 10/06

(52) U.S. Cl. CPC G06Q 10/0637
USPC 705/7.36

(57) ABSTRACT

A computer system establishes partner relationships between vendors in a vendor management and maintenance system. The computer system receives a request from a first computing device associated with a first vendor to establish a relationship with a second vendor. The computer system generates a unique relationship key associated with the second vendor. The computer system receives one or more signals comprising information relating to a copy of the unique relationship key from the first computing device associated with the first vendor. Based on receiving the copy of the unique relationship key, the computer system establishes the relationship between the first vendor and the second vendor.

### BACKGROUND

Retailers include entities that sell merchandise. For example, a retailer is a business that retails general merchandise to consumers. In another example, a retailer is a business that wholesales merchandise to other businesses.

Retailers often work with many different vendors to supply merchandise or services. A vendor is any supplier of merchandise or services and may work with the retailer directly, through an agent, or through another vendor. In some instances, multiple vendors work together to supply merchandise or services to a retailer. The retailer might not be informed about the relationships between different vendors who work together.

### SUMMARY

In general, a computer system facilitates management of business partner relationships between vendors, including, e.g., vendors of a retailer. In one example, the computer system receives a request from a computing device associated with a first vendor to establish a relationship with a second vendor. The computer system generates a unique relationship key associated with the second vendor. The computer system receives one or more signals comprising information relating to a copy of the unique relationship key from the computing device associated with the first vendor. Based on receiving the copy of the unique relationship key, the computer system establishes the relationship between the first vendor and the second vendor.

In another example, a computer system includes one or more computer-readable storage media and one or more processors coupled to the one or more computer-readable storage media. Execution by the one or more processors of instructions stored on the one or more computer-readable storage media causing the computer system to receive a request from a first computing device associated with a first vendor to establish a relationship with a second vendor, generate a unique relationship key associated with the second vendor, receive one or more signals comprising information relating to a copy of the unique relationship key from the first computing device associated with the first vendor, and based on receiving the copy of the unique relationship key, establish the relationship between the first vendor and the second vendor.

In another example, a computer program product includes one or more computer-readable storage media that store instructions that, when executed by one or more processors, cause a computer system to receive a request from a computing device associated with a first vendor to establish a relationship with a second vendor, generate a unique relationship key associated with the second vendor, receive one or more signals comprising information relating to a copy of the unique relationship key from the computing device associated with the first vendor, and based on receiving the copy of the unique relationship key, establish the relationship between the first vendor and the second vendor.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram that illustrates an example environment in which the techniques of this disclosure may be implemented.

FIG. 2 is a block diagram that illustrates an example configuration of a server device including vendor management system communicatively coupled to two or more client devices.

FIG. 3 is a block diagram of an example configuration of a computer system in which the techniques of this disclosure may be implemented.

FIG. 4 is a conceptual diagram that illustrates an example configuration of business partner relationships between a vendor and other vendors in a vendor management system.

FIG. 5 is a flowchart that illustrates an example method for establishing a business partner relationship between two vendors in a vendor management system, in accordance with techniques described herein.

FIGS. 6A-6G are screenshots that illustrate example graphical user interfaces (GUIs) for a vendor management system used to establish or manage business partner relationships, in accordance with techniques described herein.

FIG. 7 is a flowchart that illustrates another example method for establishing a business partner relationship between two vendors in a vendor management system, in accordance with techniques described herein.

In accordance with common practice, the various described features are not drawn to scale and are drawn to emphasize features relevant to the present application. Like reference characters denote like elements throughout the figures and text.

### DETAILED DESCRIPTION

As described below, a computer system includes a vendor management and maintenance system that maintains relationships between vendors that work together to supply a retailer with merchandise. For purposes of this disclosure, the vendor management and maintenance system is abbreviated “vendor management system” or VMM.

A retailer may wish to know which vendors are working for the retailer and whom those vendors are working with. For example, a sales representative does business with a merchandise vendor by acting as a consultant toward the retailer. Through the vendor management system, the retailer is informed of which vendors are working together to supply merchandise to the retailer. The retailer can use the VMM to assist with managing its inventory and ordering of supplies. For example, when an item, such as a shirt, is purchased from the retailer, the retailer can consult the VMM to determine which vendors worked together to supply the shirt, and how the vendors relate to each other. The retailer is able to determine which sales representative, manufacturer, designer, and fabric supplier were involved in supplying the shirt through the VMM. In some examples, the retailer uses this information to improve its inventory and increase future sales.

The retailer configures what types of partner relationships are allowed in the vendor management system. Vendors enroll in the vendor management system, which may be through application to the retailer. Each vendor has a unique log-in and password to the vendor management system.

The vendor management system issues a vendor a unique relationship key. To establish a relationship, the first vendor distributes its unique relationship key to a second vendor with which it wishes to have a relationship. The second vendor submits a copy of the unique relationship key to the vendor management system to establish a relationship request with the first vendor through the vendor management system. The first vendor approves the relationship request from the second vendor. The vendor management system authorizes the relationship. In some examples the first vendor does not have to approve of the relationship request after the second vendor submits the first vendor's relationship key, because the first vendor demonstrated it approved of the relationship by providing a copy of its unique relationship key to the second vendor.

Once a relationship is established between two vendors in the vendor management system, the vendors are able to share information amongst each other. Examples of such information includes information relating to contacts associated with the vendors, such as contact information for a manager, sales representative, supplier, inventory representative, or any other information relating to a person or job position designated by the vendor. Other information the two vendors can share include any information relevant to the functioning of the business relationship between the two vendors in the future, such as, but not limited to, brands, factory information, or the like.

Techniques described herein reduce the occurrence of duplicative data in the vendor management system. For example, each vendor has only one set of log-in information to the system vendor management, instead of having a separate log-in for each relationship the vendor has with other vendors. Using the single log-in, a vendor can set up one or more contacts for other vendors or businesses to which they are connected.

In some examples, a server device maintains the vendor management system. For example, a server device receives a request from a computing device associated with a first vendor to establish a relationship with a second vendor. The server device generates a unique relationship key associated with the second vendor. For example, the server device either generates the unique relationship key associated with the second vendor when the second vendor enrolled in the VMM or responsive to receiving the relationship request. The server device receives one or more signals comprising information relating to a copy of the unique relationship key from the computing device associated with the first vendor. Based on receiving the copy of the unique relationship key, the server device establishes the relationship between the first vendor and the second vendor.

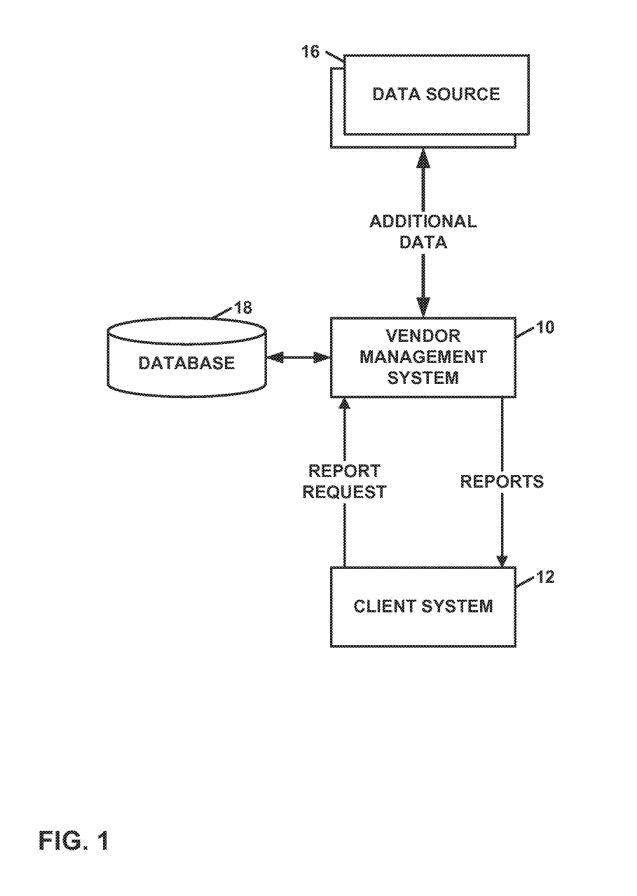

FIG. 1 is a block diagram that illustrates an example environment in which techniques of this disclosure may be implemented. As illustrated in the example of FIG. 1, the environment includes a vendor management system 10, a client system 12, a plurality of data sources 16, and a database 18. In other examples, the environment includes more, fewer, or different systems or components.

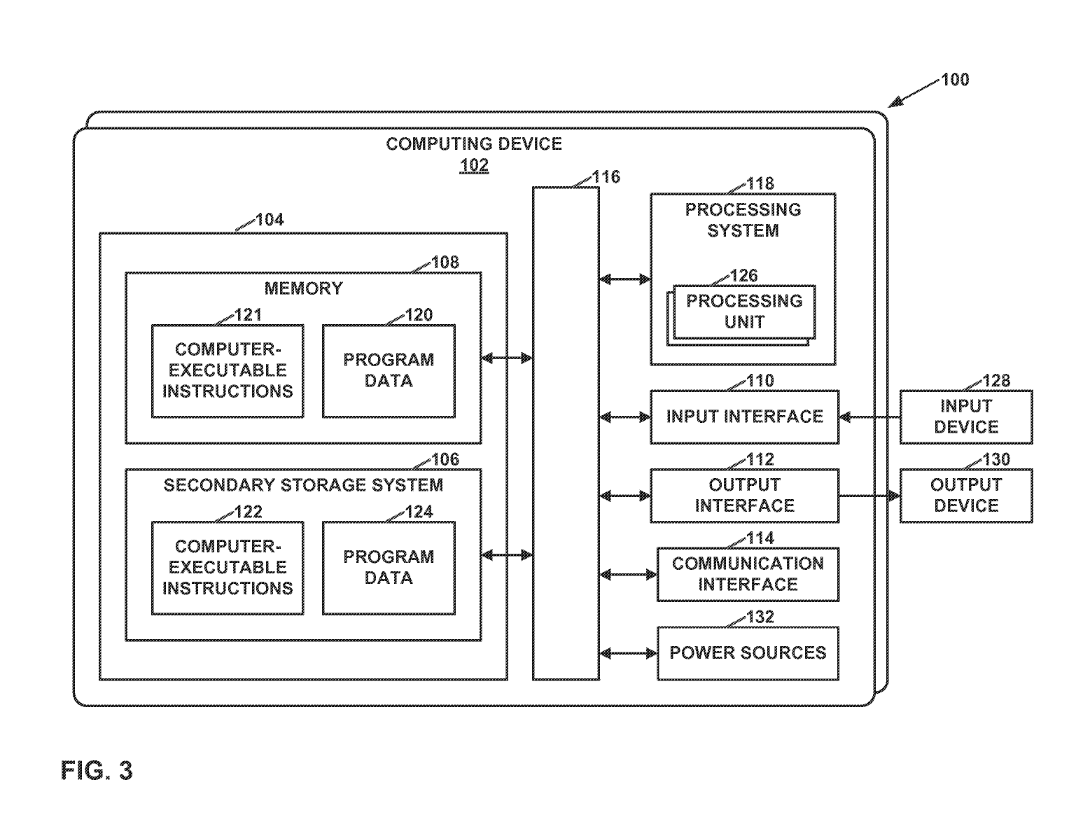

Vendor management system 10 and client system 12 is implemented in various ways in different examples. For example, vendor management system 10 and client system 12 are implemented as one or more software systems executed by one or more computing devices. FIG. 3, described in detail below, illustrates an example computer system that executes a software system to implement vendor management system 10, client system 12, data sources 16, and/or database 18. Example types of computing devices include personal computers, laptop computers, mainframe computers, tablet computers, server computers, smartphones, workstation computers, and other types of physical computing devices. In other examples, vendor management system 10, client system 12, data sources 16, and/or database 18 are implemented as least in part using computing devices that have hardware specifically designed to implement vendor management system 10, client system 12, data sources 16, and/or database 18.

Database 18 is implemented in various ways. For example, database 18 is implemented as one or more relational databases, file systems, flat files, associative databases, object-oriented databases, or other types of data structures.

Vendor management system 10 can communicate with client system 12, database 18, and data sources 16 in various ways. For example, vendor management system 10 is able to communicate with client system 12, database 18, and data sources 16 via one or more communication networks, such as local area networks (LANs), virtual private networks, or the Internet.

In some examples, a retailer is an entity that provides services or retails merchandise through physical, tangible, non-Internet-based retail stores or through Internet-based stores. Physical stores of a retailer could include a building or other physical facility that is designed with a sales floor including checklanes, checkout counters, checkout lines, cash registers, aisles, and shelves and other fixtures to present and sell merchandise to customers of the retailer. In general, vendors of a retailer include entities, such as other retailers or suppliers, from which the retailer receives merchandise or services, either directly or indirectly. This disclosure also refers to vendors as “suppliers” or “agents.” Two or more vendors can work together in a business relationship in order to supply a retailer with merchandise or services. As used herein, the term “merchandise” broadly refers to any tangible object or service that a retailer provides to a customer.

In some examples, the data in vendor management system 10 is updated on a recurring basis. For example, the data in vendor management system 10 is updated once per time interval. For instance, the data in vendor management system 10 is updated at least once per hour (e.g., once per fifteen minutes). In this example, the data in vendor management system 10 is updated to reflect changes in the business relationships between the retailer's vendors during the previous time interval. In some examples, the data in vendor management system 10 is updated whenever a partner relationship is established or ended.

The vendor management system 10 manages and provides information about the retailer's business partners. For example, vendor management system 10 maintains relationships between vendors who supply the retailer. For example, a business partner is responsible for or has relationships with multiple vendors of the retailer. In this example, the vendor management system 10 provides maps of relationships from vendors to business partners. Vendor management system 10 is also referred to as a business partner management (BPM) system. The retailer manages vendor management system 10. Each vendor enrolls in an account in vendor management system 10 and receives a unique username for each vendor. Vendors also have a password that is used to interact with vendor management system 10.

Vendor management system 10 issues a unique relationship key for each vendor in the system. A unique relationship key is, for example, any alphanumeric string or computer file that is associated with a particular vendor and is not repeated for any other vendor in vendor management system 10. A unique relationship key is used to establish a relationship with the associated vendor. For example, a first vendor provides its unique relationship key to a second vendor that has a business relationship with the first vendor. The second vendor provides a copy of the unique relationship key to vendor management system 10 in order to verify that the first vendor authorizes the business relationship with the second vendor.

In some examples, vendor management system 10 generates a unique relationship key for a vendor approximately when the vendor enrolls in the system. In other examples, vendor management system 10 generates a unique relationship key at the request of the vendor. In some example, whenever a unique relationship key is issued for a vendor, any previous unique relationship key is deactivated. Vendor management system 10 will not accept a deactivated unique relationship key that is used to establish a relationship with the associated vendor.

Vendor management system 10 stores data in database 18 in some examples. Database 18 may be separate from or part of vendor management system 10. Data stored in database 18 includes information related to vendors enrolled in vendor management system 10. Such information includes, for example, contact information such as physical addresses, email addresses, contact information for employees of the vendor, identifying information for the merchandise or services the vendor supplies, what other vendors the vendor has or is presently working with, the type of relationship to the vendor, or any other relevant information.

Vendor management system 10 also obtains data from data sources 16. Vendor management system 10 obtains data from data sources 16 in response to various events. For example, vendor management system 10 obtains data from one or more of data sources 16 in response to receiving a request for a report. Information available from data sources 16 includes tables that provide information about which merchandise is purchased by various groups of divisions, divisions, and departments of the retailer. Data sources 16 also provide information related to a process of ordering merchandise from vendors. A vendor receives orders from either the retailer or one of the vendor's business partners. The information provided by data sources 16 includes purchase orders, quantities, shipment dates, and other information about the process of ordering merchandise from vendors. Other information includes information about recorded sales of merchandise.

Vendor management system 10 obtains data from database 18 and/or data sources 16 in various ways. For example, vendor management system 10 issues a query, such as a SQL query, to database 18 or data sources 16. In another example, vendor management system 10 implements an application programming interface (API) containing one or more operations that are invoked to obtain the data from database 18 or data sources 16. In another example, vendor management system 10 implements a web server that sends the data to vendor management system 10 in response to web services requests, such as hypertext transfer protocol (HTTP) requests.

In some examples, client system 12 is a system that interacts directly with vendors. For example, client system 12 obtains information from vendors and provides that information to vendor management system 10. Furthermore, client system 12 provides an interface for vendors to be able to exchange information with their business partners and to obtain information from vendor management system 10. Vendors request information using client system 12. As used herein, any request from a vendor or retailer for information is referred to as a report request.

Vendor management system 10 receives report requests from client system 12 in some instances. In response to receiving a report request from client system 12, vendor management system 10 generates a report and outputs the report. The report includes data regarding business partners of a vendor and various parameters of the business relationship between the vendors, such as what merchandise is being exchanged. For example, for a particular vendor, the report identifies the other vendors the vendor is in partner relationships with, what type of relationships the partner relationships are, what merchandise or supplies are exchanged between the vendors, what products the vendor supplies to the retailer, or any other information. In another example, the report indicates historical or statistical information associated with the vendor, such as past partner relationships, how much inventory the vendor supplied, or the like.

After vendor management system 10 generates a report, vendor management system 10 outputs the report. Vendor management system 10 may output the report in various ways. For example, vendor management system 10 outputs the report by transmitting data representing the report to client system 12 via a communication network. In another example, vendor management system 10 writes data representing the report to a physical computer-readable storage medium, such as an optical disc, a floppy disk, a solid-state memory device (e.g., a thumb drive), and so on. In another example, vendor management system 10 outputs the report by printing the report to paper. In another example, vendor management system 10 outputs the report on a display screen.

The data representing the report includes data formatted in various ways in different examples. For example, the data representing the report includes Hypertext Markup Language (HTML), extensible markup language (XML), a word processor document, a spreadsheet document, comma separated values (CSV) formatted data, portable document format (PDF), and/or data formatted in other ways.

Upon receiving the report from vendor management system 10, client system 12 presents the report to one or more vendors. Client system 12 may present the report in various ways. For example, client system 12 outputs the report in a web browser application. In another example, client device 12 displays the report in a special-purpose application, such as a spreadsheet application, a word processor application, a database access application, or another type of application.

In this way, a computer system that implements vendor management system 10 manages business partner relationships between different vendors that work together to supply merchandise to the retailer that maintains vendor management system 10. Each vendor has a single identity in vendor management system 10 that is used for every business relationship the vendor is a party to. Vendors in business relationships can use vendor management system 10 to share information with each other.

The retailer can use vendor management system 10 to determine which vendors are working with each other. In some examples, vendor management system 10 has user configurable settings, including privacy settings, which types of business relationships are allowed, what information is available to what vendors, or any other setting. For example, the retailer designates what information may be visible to participating vendors through vendor management system 10. For example, the retailer prevents a first vendor, who is business partners with a second vendor, from seeing what other vendors the second vendor is also business partners with. In such a manner, confidentiality is ensured for the vendors.

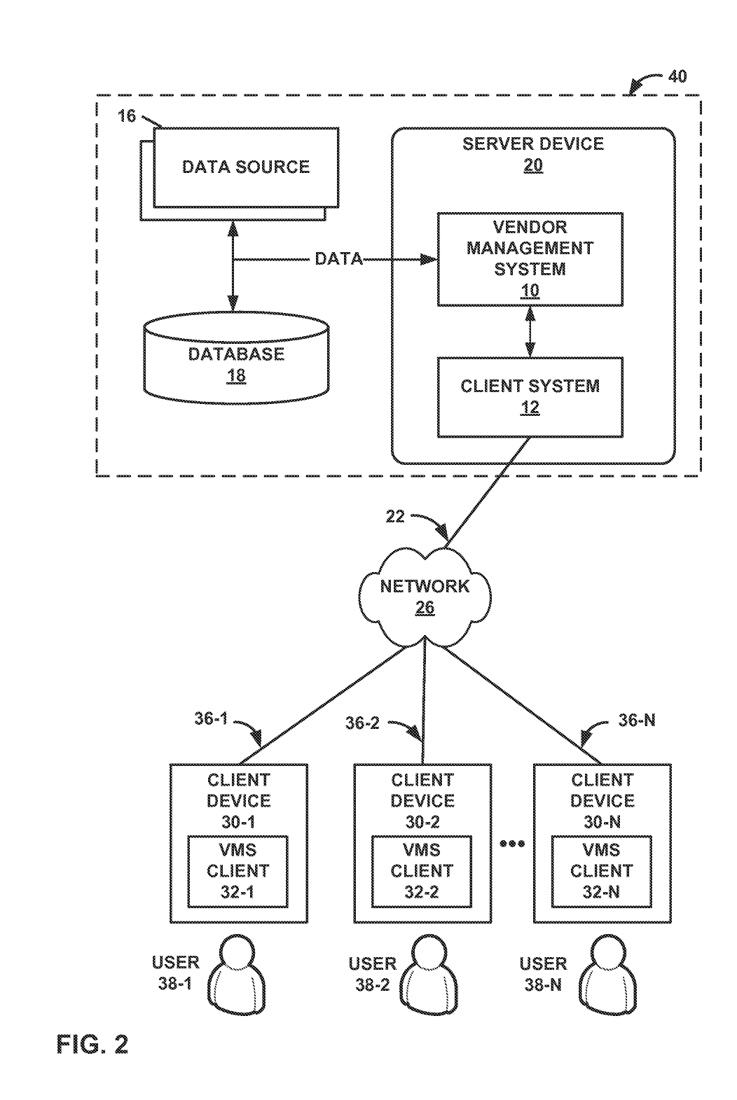

FIG. 2 is a block diagram that illustrates an example configuration of a server device 20 including vendor management system 10 communicatively coupled to two or more client devices 30-1 through 30-N. In this example, retailer 40 maintains server device 20 and vendor management system 10. Client devices 30-1 through 30-N (referred to collectively as “client devices 30”) communicate with server device 20 via network 26. For purposes of describing the example of FIG. 2, vendors use one or more client devices 30 to communicate with other vendors who are their business partners. A retailer uses server device 20 and maintains and controls vendor management system 10. Various components described in FIG. 2 include similar properties and characteristics as described throughout this disclosure.

In the example of FIG. 2, server device 20 includes vendor management system 10 and client system 12, which function as described above with respect to FIG. 1. Server device 20 sends to or retrieves data from one or more data sources 16 and database 18. As shown in FIG. 2, database 18 and data sources 16 are external to server device 20. However, in other examples, database 18 and data sources 16 are internal to server device 20. Vendor management system 10 manages database 18. For instance, vendor management system 10 stores data into database 18 and retrieves data from database 18 in response to queries received by vendor management system 10.

In other examples, server device 20 includes more, fewer, or different components. Server device 20, including the particular systems, components, and modules illustrated in the example of FIG. 2, are implemented in software, hardware, or a combination of both software and hardware components. Various components of server device 20 can be implemented in a single computing device or distributed across multiple computing devices collocated or communicatively connected between a number of locations.

Examples of client devices 30 include, but are not limited to, portable or mobile devices such as mobile phones (including smart phones), laptop computers, personal digital assistants (PDAs), desktop computers, or any other computing device. Client devices 30 may be the same or different types of devices. FIG. 2 illustrates an example with three client devices 30. However, any other natural number, N, of client devices 30 are present in other examples.

Each client device 30-1 through 30-N includes a vendor management system (VMM) client 32-1 through 32-N (collectively referred to as “VMM clients 32”). VMM clients 32 can be used to interface with VMM 10 of server device 20. For example, a VMM client 32-1 is an application executed by client device 30-1 that connects client device 30-1 to vendor management system 10, which includes an example of a web browser. Interacting with VMM client 32-1 enables user 38-1 to create, manage, maintain, or otherwise interact with business partner relationships with other vendors. VMM client 32-1 can also be used to store or retrieve data in database 18 or data sources 16.

As illustrated in FIG. 2, each client devices 30-1 through 30-N communicates with server device 20 through network 26 via at least one communication channel 36-1 through 36-N, respectively. Server device 30 communicates with network 26 via communication channel 22.

Users 38-1 through 38-N (collectively referred to as “users 38”) can interact with client devices 30-1 through 30-N, respectively. Users 38 are members or representatives of vendors that do business with or for the retailer associated with server device 20. Users 38 establish business partner relationships between the vendor they are part of and another vendor in vendor management system 10. Users 38 define one or more parameters of the business relationships with their partner vendors, such as what type of partnership it is, what information is shared, etc.

In one example, vendor management system 10 includes or has access to contact information for users 38. In some examples, two or more retailers use server device 20 and vendor management system 10.

FIG. 3 is a block diagram of an example configuration of a computer system 100 in which the techniques of this disclosure may be implemented. In the example of FIG. 3, computer system 100 comprises a computing device 102 and one or more other computing devices. Computer system 100 or similar computing systems implement vendor management system 10, client system 12, database 14, and/or data sources 18. For example, computer system 100 is an example server device 20 of FIG. 2. In another example, computer system 100 implements vendor management system client 32. In such an example, computer system 100 is an example client device 30 of FIG. 2. FIG. 3 illustrates only one particular example of computer system 100, and many other example embodiments of computer system 100 are used in other instances.

Computing device 102 is a physical device that processes information. In the example of FIG. 3, computing device 102 comprises a data storage system 104, a memory 108, a secondary storage system 106, a processing system 118, an input interface 110, an output interface 112, a communication interface 114, one or more power sources 132, and one or more communication media 116. Communication media 116 enable data communication between processing system 118, input interface 110, output interface 112, communication interface 114, memory 108, and secondary storage system 106. Computing device 102 can include components in addition to those shown in the example of FIG. 3. Furthermore, some computing devices do not include all of the components shown in the example of FIG. 3. Each of components 104, 106, 108, 110, 112, 114, 116, 118, 120, 121, 122, 124, 126, 128, 130, and 132 may be interconnected (physically, communicatively, or operatively) for inter-component communications.

A computer-readable medium is a medium from which a processing system can read data. Computer-readable media includes computer storage media and communications media. Examples of computer storage media include physical devices that store data for subsequent retrieval. Computer storage media are not transitory. For instance, computer storage media do not exclusively comprise propagated signals. Computer storage media includes volatile storage media and non-volatile storage media. Example types of computer storage media include random-access memory (RAM) units, read-only memory (ROM) devices, solid state memory devices, optical discs (e.g., compact discs, DVDs, BluRay discs, etc.), magnetic disk drives, electrically-erasable programmable read-only memory (EEPROM), programmable read-only memory (PROM), magnetic tape drives, magnetic disks, and other types of devices that store data for subsequent retrieval. Communication media includes media over which one device can communicate data to another device. Example types of communication media include communication networks, communications cables, wireless communication links, communication buses, and other media over which one device is able to communicate data to another device.

Examples of data storage system 104 are a system that stores data for subsequent retrieval. In the example of FIG. 3, data storage system 104 comprises memory 108 and secondary storage system 106. Memory 108 and secondary storage system 106 store data for later retrieval. In the example of FIG. 3, memory 108 stores computer-executable instructions 121 and program data 120. Secondary storage system 106 stores computer-executable instructions 122 and program data 124. Physically, memory 108 and secondary storage system 106 each comprise one or more computer storage media.

Processing system 108 is coupled to data storage system 104. Processing system 118 reads computer-executable instructions from data storage system 102 and executes the computer-executable instructions. Execution of the computer-executable instructions by processing system 118 can configure and/or cause computing device 102 to perform the actions indicated by the computer-executable instructions. For example, execution of the computer-executable instructions by processing system 108 can configure and/or cause computing device 102 to provide Basic Input/Output Systems (BIOS), operating systems, system programs, application programs, or can configure and/or cause computing device 102 to provide other functionality.

Processing system 118 reads the computer-executable instructions from one or more computer-readable media. For example, processing system 118 reads and executes computer-executable instructions 121 and 122 stored on memory 108 and secondary storage system 106.

Processing system 118 comprises one or more processing units 126. Processing units 126 comprise physical devices that execute computer-executable instructions. Processing system 118 also includes one or more operating systems that are executable by computing device 102. Examples of processing units 126 comprise various types of physical devices that execute computer-executable instructions. For example, one or more of processing units 126 comprise a microprocessor, a processing core within a microprocessor, a digital signal processor, a graphics processing unit, or another type of physical device that executes computer-executable instructions.

Input interface 110 enables computing device 102 to receive input from an input device 128. Input device 128 comprises a device that receives input from a user. Input device 128 comprises various types of devices that receive input from users. For example, input device 128 is a keyboard, a touch screen, a mouse, a microphone, a keypad, a joystick, a brain-computer interface device, or another type of device that receives input from a user. In some examples, input device 128 is integrated into a housing of computing device 102. In other examples, input device 128 is outside a housing of computing device 102. In some examples, input device 128 receives report requests, inventory data, and/or other types of data as described above.

Output interface 112 enables computing device 102 to output information on one or more output devices 130. One or more output devices 130, in some examples, are configured to provide output to a user using tactile, audio, or video output. For example, an output device 130 is a device that displays output. Example types of display devices include monitors, touch screens, display screens, televisions, and other types of devices that display output. In some examples, output device 130 is integrated into a housing of computing device 102. In other examples, output device 130 is outside a housing of computing device 102. In some examples, output device 130 displays reports or other types of data as described above. Output devices 130, in one example, includes a presence-sensitive screen or a touch screen. Output devices 130 utilize a sound card, a video graphics adapter card, or any other type of device for converting a signal into an appropriate form understandable to humans or machines. Additional examples of output device 130 include a speaker, a cathode ray tube (CRT) monitor, a liquid crystal display (LCD), or any other type of device that can generate intelligible output to a user.

Communication interface 114 enables computing device 102 to send and receive data over one or more communication media. In some examples, computing device 102 utilizes one or more communication interfaces 114 to wirelessly communicate with an external device such as server device 20 or a client device 30 of FIG. 2, a mobile phone, or other networked computing device. Communication interface 114 comprises various types of devices. For example, communication interface 114 comprises a Network Interface Card (NIC), a wireless network adapter, a Universal Serial Bus (USB) port, or another type of device that enables computing device 102 to send and receive data over one or more communication media. In some examples, communications interface 114 comprises a network interface to communicate with external devices via one or more networks, such as one or more wireless networks. Examples of communications interface 114 include an Ethernet card, an optical transceiver, a radio frequency transceiver, or any other type of device that can send and receive information. Other examples of such network interfaces include Bluetooth®, 3G and WiFi® radios in mobile computing devices. In some examples, communication interface 114 receives configuration data, trial data, and/or other types of data as described above. Furthermore, in some examples, communication interface 114 outputs information and/or other types of data as described above.

Computing device 102, in some examples, includes one or more power sources 132, which may be rechargeable and provide power to computing device 102. The one or more power sources 132 can be one or more batteries. Examples of the one or more batteries are made from nickel-cadmium, lithium-ion, or any other suitable material. In another example, the one or more power sources 132 include a power supply connection that receives power from a power source external to computing device 102.

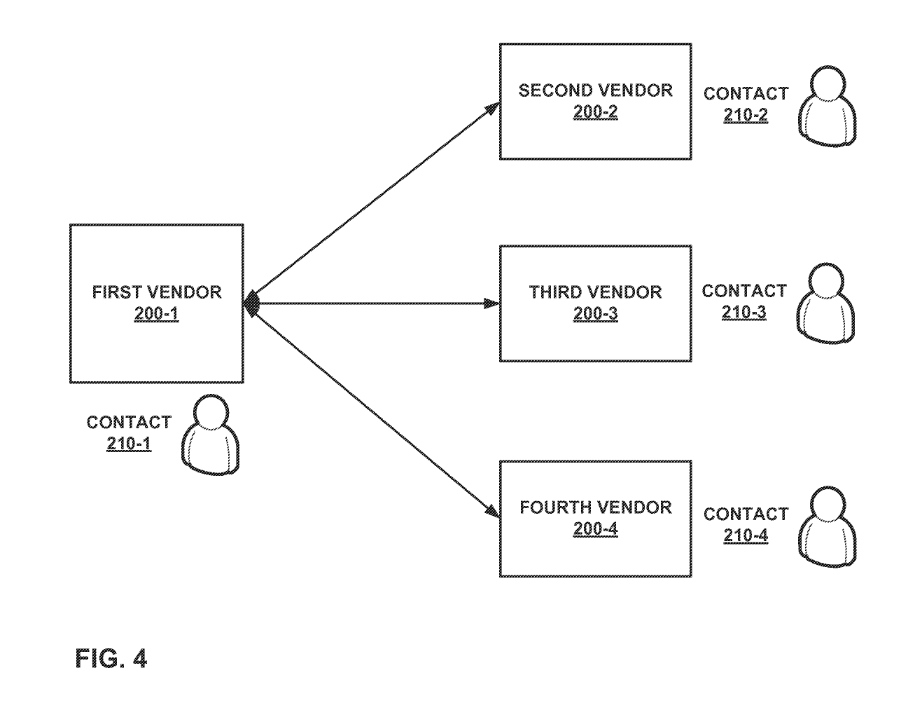

FIG. 4 is a conceptual diagram that illustrates an example configuration of business relationships between a vendor and other vendors in a vendor management system. The example configuration illustrated in FIG. 4 may be implemented in vendor management system 10 of FIGS. 1 and 2. Vendors 200-1 through 200-4 (collectively referred to as “vendors 200”) have each been enrolled in a VMM.

In this example, first vendor 200-1 has three business partner relationships 220-1 through 220-3 (collectively referred to as “partner relationships 220”) between three different vendors: second vendor 200-2, third vendor 200-3, and fourth vendor 200-4. That is, first vendor 200-1 has a first partner relationship 220-1 established with second vendor 200-2. First vendor 200-1 has a second partner relationship 220-2 established with third vendor 200-3 and a third partner relationship 220-3 established with fourth vendor 200-4.

Each partner relationship 220 is a type of partner relationship that is approved by the VMM. For example, retailer 40 determines which partner types can form relationships together. Retailer 40 allows relationships for business partners that can work together to supply merchandise to or services for retailer 40. For example, an air freight forwarder forms a partner relationship with vendors such as a fabric supplier, a trim supplier, a design partner, a distributor, or a sales representative. Other examples are contemplated herein, such as a relationship between a merchandise vendor and a fabric supplier, or a sales representative and a merchandise vendor.

Using the VMM, the retailer will know which vendors are working together to supply the retailer with merchandise. The VMM thus informs the retailer of which vendors are working for the retailer and business relationships between the vendors. Within the relationships, the VMM creates a foundation for the vendors to share information between themselves through the VMM.

Each vendor 200 has one or more contacts represented in the vendor management system. As shown in FIG. 4, first vendor 200-1 has a contact 210-1, second vendor 200-2 has a contact 210-2, third vendor 200-3 has a contact 210-3, and fourth vendor 200-4 has a contact 210-4. In other examples, vendors 200 have other numbers of contacts. Contacts 210-1 through 210-4 (referred to collectively as “contacts 210”) are representatives of their respective vendor. Contacts 210 may also play a role for the specific partner relationship between vendors.

In some examples, the retailer configures what types of vendor relationships are allowed in the VMM. Further, in some examples, the retailer configures which of those relationships are allowed to share contacts. In some examples, the retailer also determines in which directions the contacts can be shared. Vendors can share contacts and then set up a shared contact with system access on behalf of the partner vendor they were shared to. In some examples, the vendor administrator has total control of what information the shared contact can or cannot access.

In one example, a contact for a vendor is entered into the VMM only once. That contact can then be shared from the vendor to other vendors that the contact works with. In this manner, the same contact is not entered into the VMM multiple times. Further, in some examples, the contact only has a single user identity within the VMM. Regarding the contact, the other vendors can then determine what kind of system access they want the contact to have within the context of their own companies.

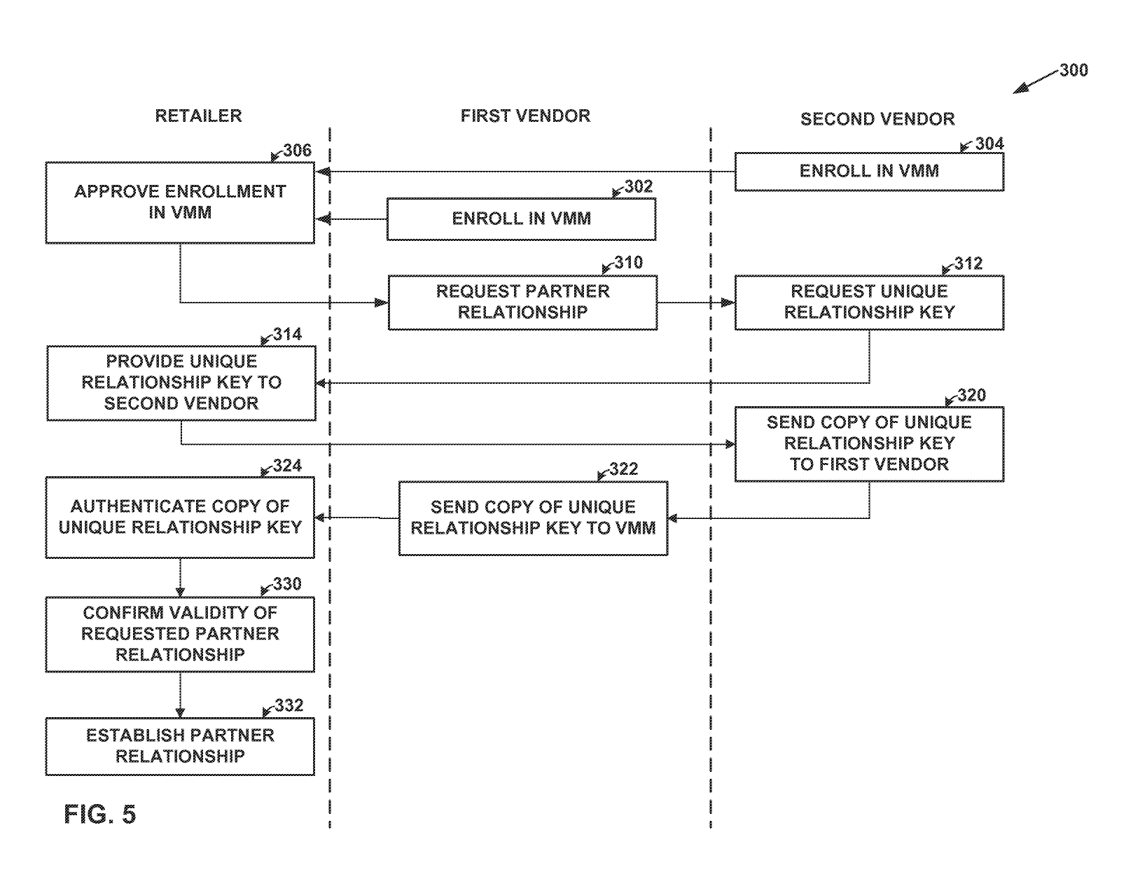

FIG. 5 is a flowchart that illustrates an example method for establishing a business partner relationship between two vendors in a vendor management system, in accordance with techniques described herein. In this example, the VMM is the vendor management system 10 of FIGS. 1 and 2. FIG. 5 illustrates only one particular example of a method for establishing a business partner relationship, and many other examples may be used in other instances.

A retailer maintains a vendor management system (VMM) which functions as a tool for the retailer and vendors to manage relationships. The VMM includes information about the retailer and vendors, what the retailer and vendors do, their addresses, and information about some employees.

The retailer sets up the vendor management and maintenance system. The VMM is executed by a server device, such as server device 20 of FIG. 2. Vendors who are working for the retailer may enroll in the VMM. The VMM provides various methods for vendors to enroll in the VMM. As shown in FIG. 5, a first vendor enrolls in VMM (302). The first vendor enrolls in the VMM by, for example, accessing a publicly accessible registration page, which may be a webpage. For example, the first vendor accesses the registration page for the VMM. To register, the first vendor inputs information to the VMM system. If the vendor meets any requirements set by the retailer for enrollment to the VMM, the retailer approves the enrollment and registers the first vendor with the VMM (306). By approving the first vendor's registration in the VMM, the retailer internally approves the first vendor as a business partner of the retailer. Once registered, the VMM issues the first vendor with a user identification (ID) and password that may be used to log into the VMM. In FIG. 5, a second vendor also enrolls in the VMM (304). The second vendor enrolls in the VMM using the same publicly accessible registration page. If the second vendor meets the requirements for enrollment, the retailer approves enrollment of the second vendor in the VMM (306).

For illustrative purposes, in this example, the first vendor wishes to establish a partner relationship with the second vendor. Thus, the first vendor requests a partner relationship with the second vendor (310). The first vendor and the second vendor likely already have an established business relationship. The first vendor is requesting to have their partner relationship reflected in the VMM.

The first vendor may request the partner relationship in one or more of several different ways. For example, the first vendor contacts the second vendor directly to request a partner relationship. For example, the first vendor can make a phone call or send an email to the second vendor with which the first vendor wants to establish a partner relationship. Alternatively, the first vendor can inform the VMM that the first vendor wants to establish a partner relationship with the second vendor. In that example, the VMM communicates to the second vendor that the first vendor wants a partner relationship. In such an example, the VMM provides the first vendor's relationship key to the second vendor. Thus, vendors systematically choose who they work with. If another vendor they work with is not registered in the VMM, the enrolled vendor can refer the other vendor to begin the registration process in the VMM.

In order to establish a relationship in the VMM between two vendors, at least one of the vendors presents a copy of a unique relationship key of the other vendor to the VMM. For example, the first vendor presents a copy of a unique relationship key (also referred to herein as a “key”) of the second vendor to the VMM. A unique relationship key is, for example, an alphanumeric string, image, or other file that uniquely identifies a particular vendor in the VMM. Each vendor is aware of or has a copy of its own unique relationship key. A vendor's key is obtained by another vendor through contacting the vendor.

The VMM generates and issues a unique relationship key to each vendor that enrolls in the VMM. In the example of FIG. 5, the second vendor requests a unique relationship key from the VMM (312). The second vendor may request a key prompted by receiving a request from the first vendor to establish a partner relationship in the VMM. In some examples, the VMM generates a key for a vendor when the vendor enrolls in the VMM. For example, the VMM automatically issues a key to each new vendor who enrolls in the VMM.

If a vendor wants a new key generated, the vendor can request a new key from the VMM. The VMM resets the key without affecting any of the relationships that the vendor has. That is, the unique relationship key can be reset at any time and will not impact current or pending relationships. In some examples, the key is only used to establish a partner relationship in the VMM.

Using the unique relationship keys in the VMM reduces revealing the identities of the vendors which the retailer currently does business with among the vendors that do not have partner relationships. Every vendor has a unique VMM generated key. Keys are exchanged between vendors through, for example, the vendors contacting each other directly. For example, the first vendor can make a phone call or send an email to the second vendor with which the first vendor wants to establish a partner relationship. According to techniques described herein, the retailer does not have to manage the relationships (e.g., create and enter) between the vendors. Instead, the vendors are able to manage their relationships directly. Furthermore, by issuing keys to only those vendors who are enrolled in the VMM, vendors who have not been approved by the retailer to participate in the VMM will not be able to create partner relationships.

When the retailer or VMM system receives the request for a unique relationship key from the second vendor, the VMM generates the unique relationship key for the second vendor and provides the key to the second vendor (314). Once the second vendor knows its key, it sends a copy of the key to the first vendor if it approves and accepts the partner relationship with the first vendor (320). By sending a copy of the key to the first vendor, the second vendor is indicating that it works with the first vendor.

To confirm the partner relationship, the first vendor provides a copy of the unique relationship key of the second vendor to the VMM (322). For example, the first vendor provides a copy of the key by entering the key in a field in an electronic form through the VMM. Once the VMM receives the copy of the unique relationship key of the second vendor, the VMM authenticates the copy (324). To authenticate the copy, for example, the VMM compares the copy to the original key to determine if they are approximately the same. If the copy and the original key are the same, or within a threshold level of sameness, the VMM determines the copy is authentic.

In another example, the first vendor provides the relationship context to the VMM. For example, the first vendor informs the VMM of its context in the relationship (e.g., merchandise vendor) and the second vendor's context in the relationship (e.g., sales representative). The VMM uses the contexts in the relationship in authenticating a relationship request. For example, the VMM approves the second vendor for the relationship context (in this example sales representative) that the first vendor selected in addition to the first vendor providing the correct relationship key belonging to the second vendor.

Based on the copy being authentic (for example, the same as the original), and any other criteria, the VMM approves the partner relationship between the first and second vendors. Thus, the VMM confirms the validity of the requested partner relationship between the first vendor and the second vendor (330). In some examples, the VMM queries the second vendor to confirm that the second vendor wants to participate in the partner relationship. Once confirmed, the VMM establishes the partner relationship (332).

In sum, one example of establishing a vender partner relationship is as follows. Both vendors enroll in the VMM and are each issued unique relationship keys. At least one of the vendors contacts the other vendor to get its key. The vendor then enters the key into the VMM, and the VMM queries the other vendor to confirm the partnership. Once confirmed, the VMM ties the records of the first and second vendors together. If the second vendor denies the partner relationship, the first vendor can continue to send partner relationship requests using the copy of the key until the second vendor changes the key.

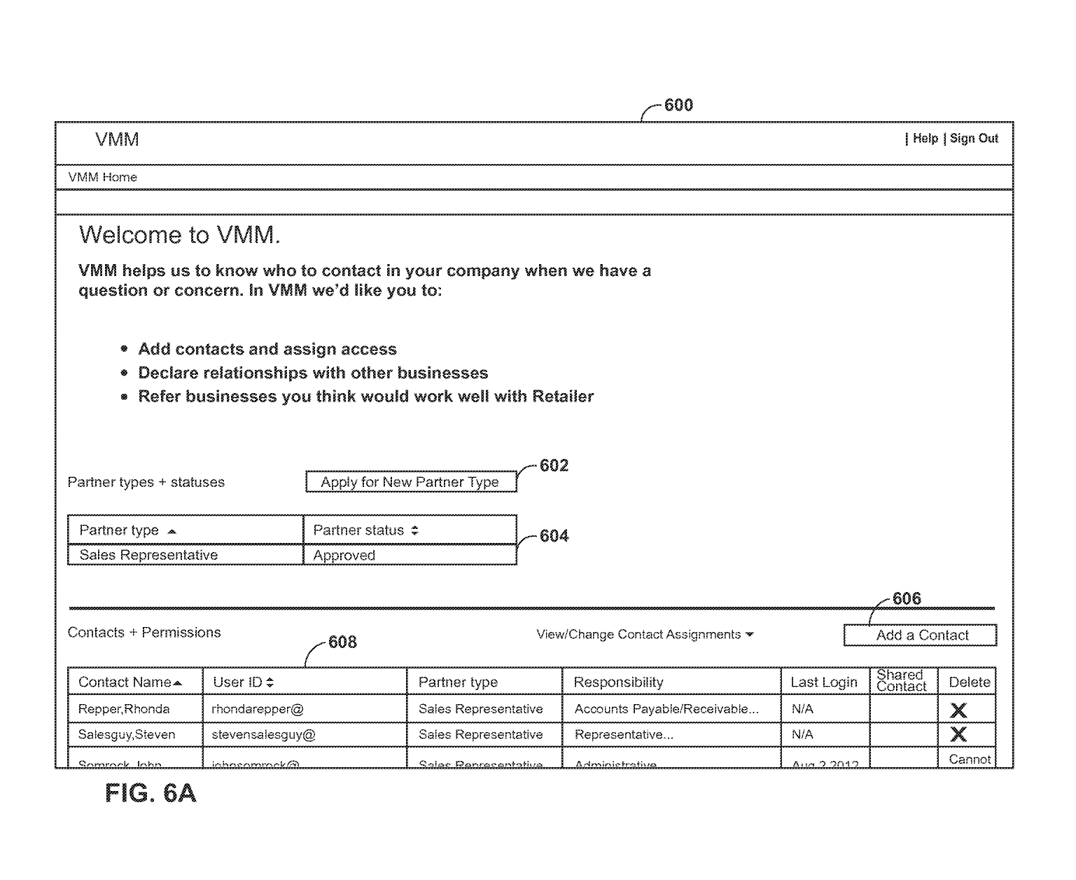

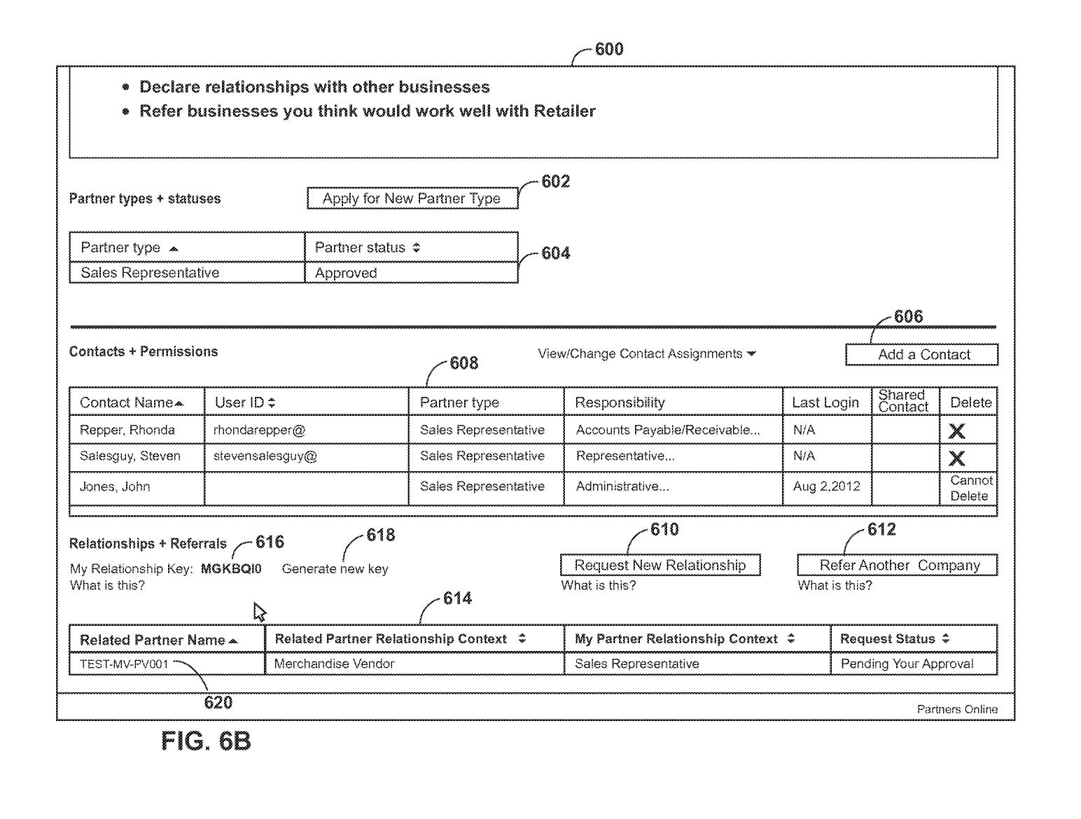

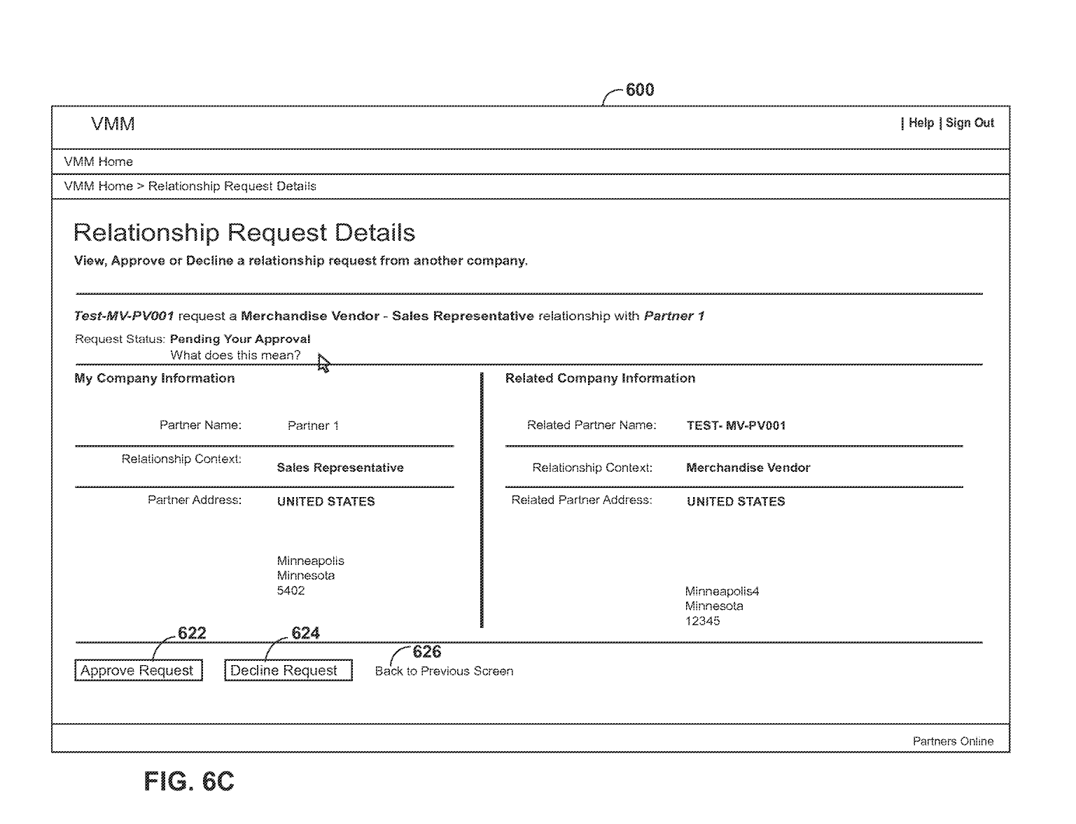

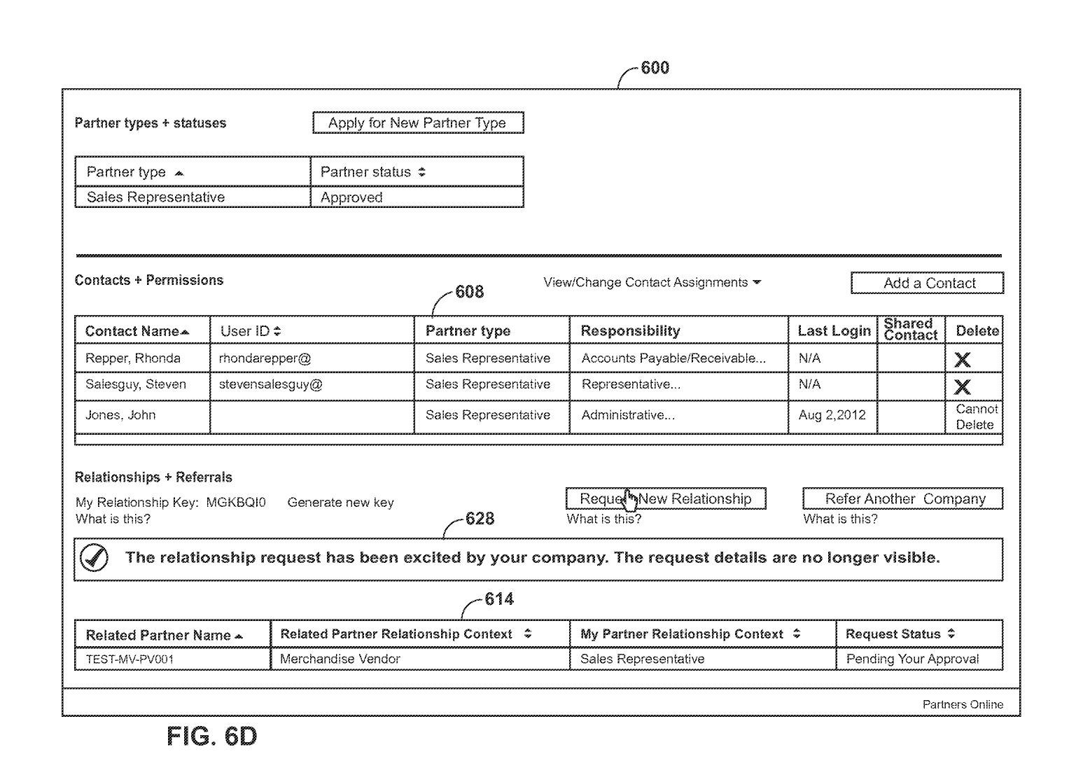

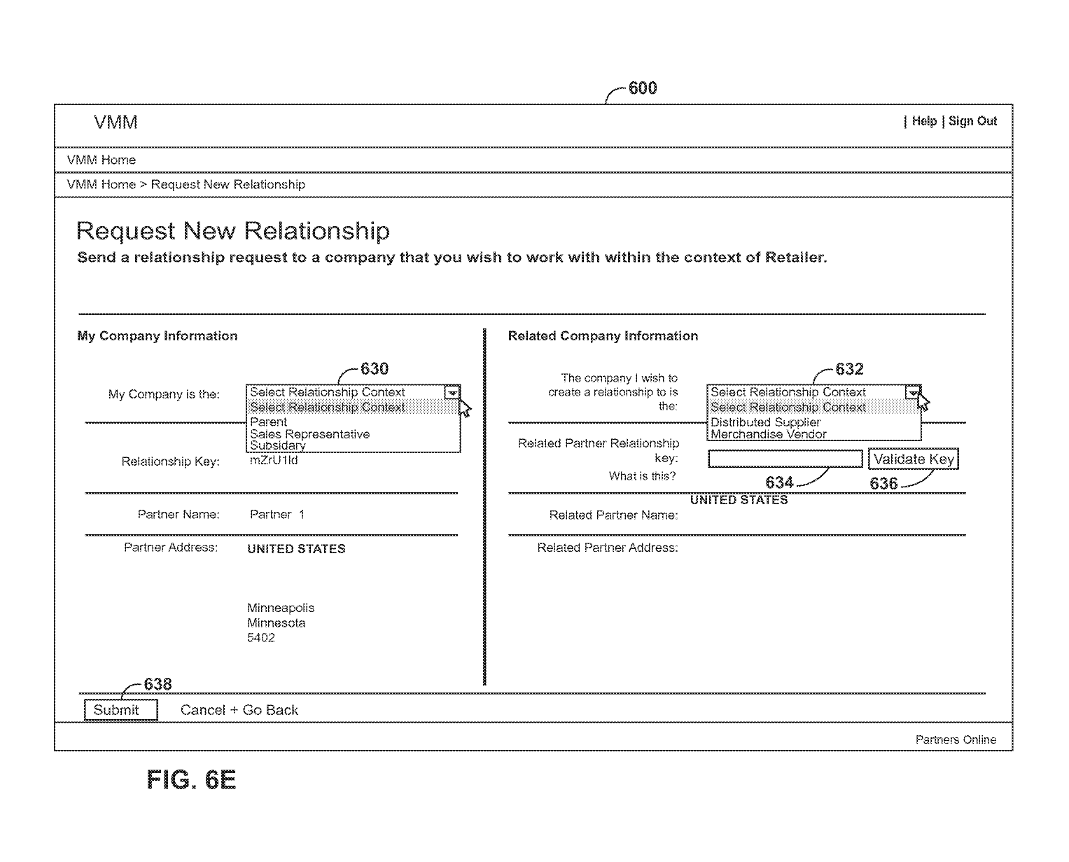

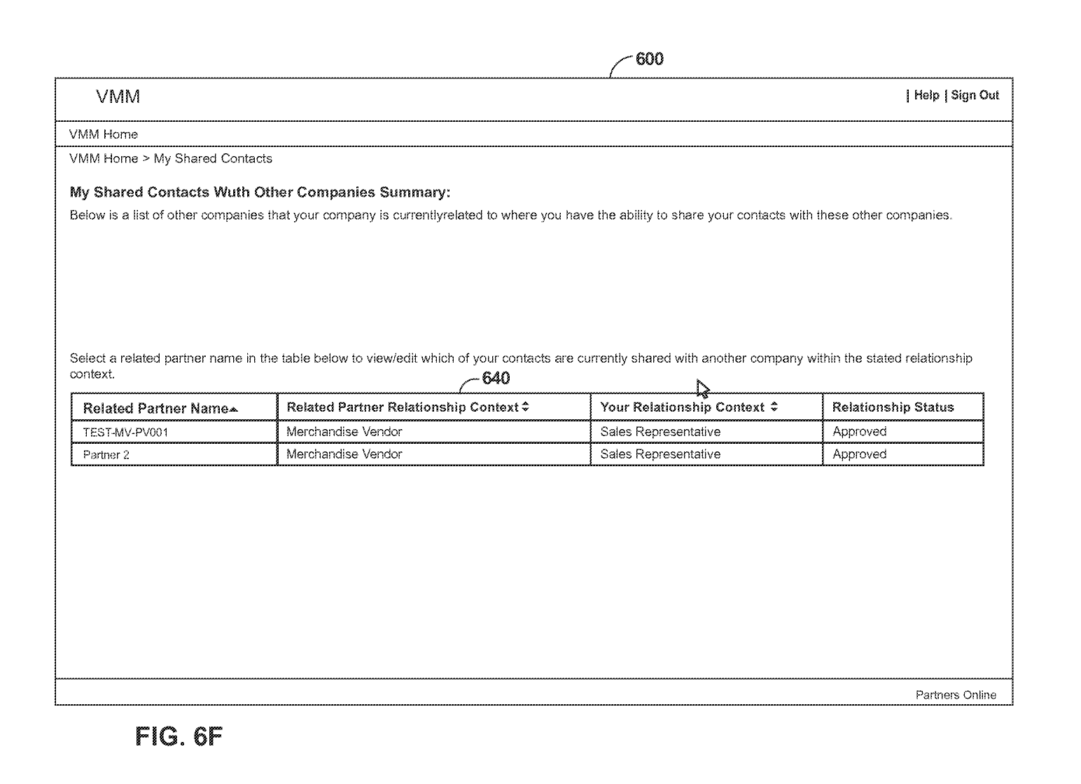

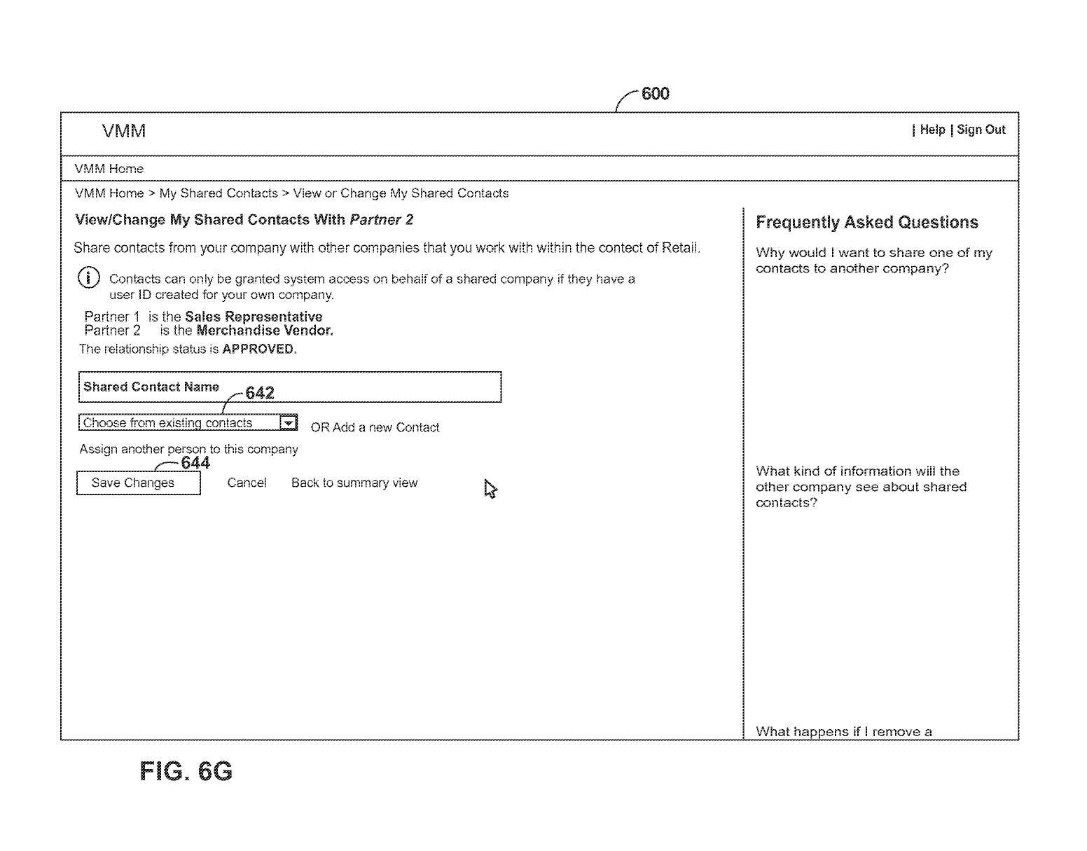

FIGS. 6A-6G are screenshots that illustrate example graphical user interfaces (GUIs) for a vendor management system used to establish or manage business partner relationships, in accordance with techniques described herein. Vendor management system 10 of FIGS. 1 and 2, server device 40 of FIG. 2, or computing system 100 of FIG. 3 may be used in providing the example GUIs of FIGS. 6A-6G. In other examples, other devices, systems, or components provides or outputs screenshots.

FIG. 6A is a screenshot of a GUI 600 of an example homepage for a vendor management and maintenance system (VMM or VMS). A vendor who is enrolled in the VMM sees this homepage when a representative of the vendor logs into the VMM. The VMM provides a tool to manage relationships between business partners that enables a retailer to strategically analyze its supply chain and reduce duplicated data. The GUI 600 shows a welcome screen that includes introductory information, buttons 602 and 606, and tables 604 and 608. Buttons 602 and 606 are user-intractable elements, such as touch-targets or other virtual buttons. A user, such as user 38-1, can interact with button 602 or 606 to access additional options or features.

Button 602 is labeled “Apply for New Partner Type” and can be used to have a business partner type, such as sales representative or merchandise vendor, be approved by a retailer in charge of the VMM, such as retailer 40. Table 604 provides information regarding partner type and partner statuses for the vendor. Relationships between business partners are established at the business partner type level as configured by an internal administrator within the VMM. In one example, an exception to this is a parent-subsidiary relationship.

Button 606 is labeled “Add a Contact” and can be used to add a contact or representative to the VMM. Table 608 provides information on contacts and permissions of the vendor. The information includes, for example, contact name, user identification (ID), contact information, partner type, responsibility, date of last login, any shared contact. In one example, an indicator is provided that indicates whether the contact has been shared from another vendor (for example, the contact is not directly employed by the vendor currently logged into the VMM). Table 608 also provides an option to delete one or more contacts.

FIG. 6B is a screenshot of GUI 600 showing the VMM homepage shown in FIG. 6A scrolled down from the position it was in FIG. 6A. FIG. 6B additionally shows buttons 610 and 612, table 614, relationship key 616, and hyperlink 618. Button 610 is labeled “Request New Relationship” and can be used to establish a new relationship with a business partner through the VMM. User 38-1 may click button 610 to create a new relationship.

Button 612 is labeled “Refer Another Company” and can be used to refer another business to retailer 40. Table 614 provides information related to the vendor's business relationships, including related partner name, related partner relationship context, the vendor's partner relationship context, and a request status of the business relationship. Table 614 further includes a hyperlink 620 for the related partner name. Interacting with hyperlink 620 may provide additional information including the business partner name, context of relationship, address, related business partner name, relationship context of related partner, relationship status, and also provide an option to take action on the relationship. In some examples, user 38-1 selecting hyperlink 620 can also provide the user with an option to approve or decline a pending partner relationship request.

In FIG. 6B, the related partner “TEST-MV-PV001” has a request status as “pending your approval” in table 614. User 38-1 interacts with hyperlink 620 to receive more information regarding the potential partner or to be presented with options to accept or decline the pending relationship request.

FIG. 6C is a screenshot of relationship request details in the vendor maintenance system. The screenshot in FIG. 6C includes information related to a pending business relationship, including information for the business of user 38-1 and information for the related vendor in the pending relationship request. The screenshot includes buttons 622 and 624 and hyperlink 626. Button 622 is labeled “Approve Request” and can be used to accept a business partner relationship. Button 624 is labeled “Decline Request” and can be used to decline a business partner relationship. Hyperlink 626 is used to return to the previous screen.

FIG. 6D is a screenshot similar to that of FIG. 6B, except now user 38-1 has approved the relationship request from the related partner “TEST-MV-PV001.” A notification 628 is provided with information related to a previous action in the VMM. In this example, notification 628 informs user 38-1 that the relationship request has been exited and the request details are no longer visible. Table 614 lists the request status for related partner “TEST-MV-PV001” as approved.

FIG. 6E is a screenshot similar of an example screen for requesting a new relationship. User 38-1 can use this interactive page to request a new partner relationship between their company and another vendor. The screenshot includes a menu 630 for selecting the relationship context of the company of user 38-1. In the example shown in FIG. 6E, the menu 630 is a pull-down menu and three options are provided: parent, sales representative, and subsidiary. Another menu 632 is also provided for selecting the relationship context. In the example shown in FIG. 6E, menu 632 is a pull-down menu and two options are provided: distribution supplier and merchandise vendor. Menu 630 provides a list of approved partner types for the business partner that have been configured in VMM, by an internal VMM administrator of the retailer, for example, to be allowed to have approved relationships with other partner types. One exception to this is a parent/subsidiary option. That is, in some examples, the parent and subsidiary relationships are available options for every vendor, while other partner types are available to vendors only for partner types the VMM has approved for that vendor. Menu 632 may provide partner types that have been configured in the VMM to have relationships with the context that was selected in menu 630. In other examples, other relationship contexts are available for either or both companies.

The screenshot of FIG. 6E further provides a field 634 for entering the related partner's relationship key. User 38-1 enters the relationship key that was received from the vendor that user 38-1 wishes to establish a business partnership with in the VMM. Once entered, user 38-1 interacts with, by clicking, for example, a button 636 labeled “Validate Key” to validate the entered relationship key. The VMM compares the relationship key entered in 634 with a copy of the second vendor's actual relationship key. If the two match and the second vendor is approved for the selected partner type, the VMM accepts the relationship key. A confirmation that the keys match is provided in some examples, such as by altering the appearance of the screen or providing a pop-up that indicates the keys match or do not match. In some examples, if the entered key does not match the vendor's actual relationship key, a generic error message is displayed to maintain confidentiality. In some cases, if the entered relationship key is valid, an email or other correspondence is sent to the vendor. A representative of the vendor may log into the VMM and accept or decline the partner relationship before it is established in the VMM.

FIG. 6F is a screenshot that provides a summary of the shared contacts of the company that is currently logged into the VMM. A table 640 provides information about shared contacts and a summary of partners that the company has the ability to share contacts with. As shown in the example of FIG. 6F, table 640 includes information regarding the related business partner, including name, relationship contexts, and relationship statuses. Within the VMM, some relationship types are configured to allow contact sharing while others are not. In some examples, a VMM administrator of retailer 40 can control which relationship types are able to share what information, and are also be able to control which direction information can be shared. Contact sharing enables companies that are in a partner relationship to share contacts between each other in order to share common goals. In some examples, the related partner name may be interacted with to access information regarding the shared contacts. In some examples, a related partner name is listed more than once if they have two or more different relationship contexts or business types.

FIG. 6G is a screenshot that shows shared contacts of the vendor that is currently logged into the VMM and a specific business partner. This page allows user 38-1 to view or change shared contacts with the business partner. For example, this page allows contacts to be added, removed, and shared. In some examples, removing a shared contact removes the contact from the shared partner but not from the VMM entirely. A menu 642 can be used to select an existing contact, view the contact's information, and possibly make changes to the contact. A button 644 enables the changes to the contacts to be saved in the VMM. In some examples, the vendor sets what information the business partner has access to. That is, the vendor is in control of what information the contact has access to on the vendor's behalf.

The screenshots of FIGS. 6A-6G illustrate only one example format of a VMM. In other examples, other formats, layouts, color schemes, user-selectable options, physical or virtual buttons, patterns, hyperlinks, or the like are different from those shown in FIGS. 6A-6G.

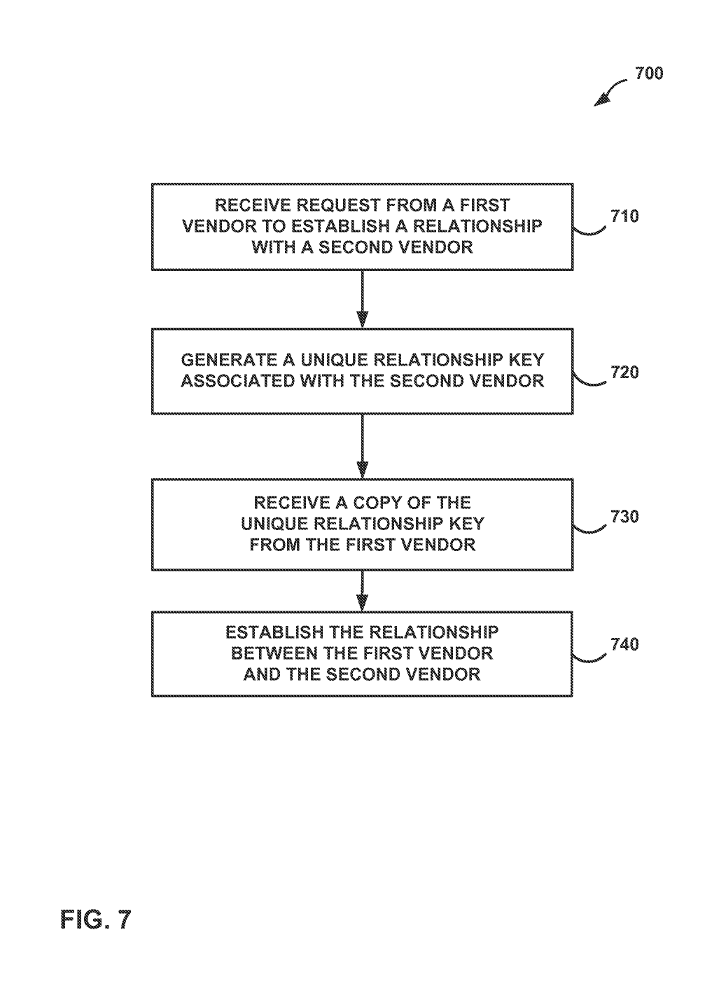

FIG. 7 is a flowchart that illustrates another example method 700 for establishing a business partner relationship between two vendors in a vendor management system, in accordance with techniques described herein. As discussed herein, method 700 is performed by vendor management system 10 of FIGS. 1 and 2, server device 40 of FIG. 2, or computing system 100 of FIG. 3. In other examples, method 700 is performed by other devices, systems, or components.

Method 700 includes receiving, by a server device, a request from a first computing device associated with a first vendor to establish a partner relationship with a second vendor in a vendor maintenance and management system (710). In some examples, method 700 further includes registering, by the server device, the first vendor in the vendor maintenance and management system.

The server device generates a unique relationship key associated with the second vendor (720). In some examples, the server device also generates a unique relationship key associated with the first vendor. The unique relationship keys are generated in response to receiving the request to establish the partner relationship, but may also be generated at other times. In some examples, the server sends one or more signals comprising the unique relationship key to a second computing device associated with the second vendor. In another example, method 700 includes receiving, by the server device, a relationship key request from a second computing device associated with the second vendor, wherein generating the unique relationship key is in response to the relationship key request.

The server device receives one or more signals comprising information relating to a copy of the unique relationship key from the first computing device associated with the first vendor (730).

Method 700 also includes establishing by the server device, based on receiving the copy of the unique relationship key, the partner relationship between the first vendor and the second vendor (740). Establishing the relationship between the first vendor and the second vendor comprises enabling sharing of information between the first vendor and the second vendor. For example, the server device receives contact information for a contact of the first vendor from the first vendor. The server device determines whether the contact of the first vendor is associated with the partner relationship. For example, a contact is associated with the partner relationship if that contact works directly with the other vendor (e.g., a sales representative of the first vendor that works with the second vendor). If the contact is associated with the partner relationship, the server device authorizes the second vendor to access the contact information. In some examples, the first vendor can identify the contact as working with the second vendor and enable sharing of the contact information.

In another example, method 700 includes receiving, by the server device, a reset request from a second computing device associated with the second vendor. Responsive to receiving the reset request, the server device resets the unique relationship key from a first value to a second value, wherein the second value is different from the first value. In some examples, resetting the unique relationship key does not change any previously established relationships with the second vendor.

In some examples, the vendor maintenance and management system stores a single data set for each vendor, such as the second vendor. A data set, for example, includes login information and any other information that the vendor uses to enter the VMM. Data is not replicated, so it is easier for the retailer to analyze their business partners than when data is replicated.

In another example, the server device receives a second request from a second computing device associated with a third vendor to establish a second partner relationship with the second vendor in the vendor maintenance and management system. The server device receives one or more signals comprising information relating to the copy of the unique relationship key from the second computing device associated with the third vendor. Based on receiving the copy of the unique relationship key, the server device establishes the second partner relationship between the third vendor and the second vendor. In some examples where the second vendor reset its key, the unique relationship key is a different relationship key than the one used to establish the partner relationship with the first vendor.

Privacy among the vendors may be maintained by keeping partner relationships confidential such that, besides the retailer, only those vendors in the partner relationship are aware of the relationship. Thus, one vendor would not be able to see what other vendors the retailer is working with. Information may not be shared with vendors in the VMM who do not have a partner relationship. For example, the first partner relationship is confidential to the third vendor and the second partner relationship is confidential to the first vendor.

The retailer defines which types of vendors are allowed to have relationships (e.g., sales representatives to merchandise vendors). In some examples, the VMM determines whether a particular partner relationship is authorized between different types of vendors. As such, the VMM determines a type of partner relationship between the first vendor and the second vendor. The VMM compares the type of partner relationship to a set of authorized partner relationships. Based on the comparison, the VMM authorizes the partner relationship when the type of partner relationship is among the set of authorized partner relationships. Alternatively, the VMM determines a first vendor category for the first vendor and a second vendor category for the second vendor. The VMM authorizes the partner relationship based on the determined first vendor category and the second vendor category.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

Various examples have been described. These examples and others are within the scope of the following claims.

1. A method, comprising:
receiving, by a server device, a request from a first computing device associated with a first vendor to establish a partner relationship with a second vendor in a vendor maintenance and management system;
generating, by the server device, a unique relationship key associated with the second vendor;
receiving, by the server device, one or more signals comprising information relating to a copy of the unique relationship key from the first computing device associated with the first vendor; and
based on receiving the copy of the unique relationship key, establishing, by the server device, the partner relationship between the first vendor and the second vendor.

2. The method of claim 1, further comprising:
sending, by the server device, one or more signals comprising the unique relationship key to a second computing device associated with the second vendor.

3. The method of claim 1, further comprising:
receiving, by the server device, a relationship key request from a second computing device associated with the second vendor, wherein generating the unique relationship key is in response to the relationship key request.

4. The method of claim 1, further comprising:
receiving, by the server device, a reset request from a second computing device associated with the second vendor; and
responsive to receiving the reset request, resetting, by the server device, the unique relationship key from a first value to a second value, wherein the second value is different from the first value and does not change any previously established relationships of the second vendor.

5. The method of claim 1, further comprising:
receiving, by the server device, one or more signals accepting establishment of the partner relationship between the first vendor and the second vendor from a second computing device associated with the second vendor.

6. The method of claim 1, wherein establishing the relationship between the first vendor and the second vendor comprises enabling sharing of information between the first vendor and the second vendor.

7. The method of claim 1, further comprising:
receiving, by the server device, contact information for a contact of the first vendor from the first vendor;
determining, by the server device, that the contact of the first vendor is associated with the partner relationship; and
authorizing, by the server device, the second vendor to access the contact information.

8. The method of claim 1, further comprising:
registering, by the server device, the first vendor in the vendor maintenance and management system; and
generating, by the server device, a unique relationship key associated with the first vendor.

9. The method of claim 1, wherein the request is a first request and the partner relationship is a first partner relationship, the method further comprising:
receiving, by the server device, a second request from a second computing device associated with a third vendor to establish a second partner relationship with the second vendor in the vendor maintenance and management system;
receiving, by the server device, one or more signals comprising information relating to the copy of the unique relationship key from the second computing device associated with the third vendor; and
based on receiving the copy of the unique relationship key, establishing, by the server device, the second partner relationship between the third vendor and the second vendor.

10. The method of claim 9, wherein the vendor maintenance and management system stores a single data set for the second vendor.

11. The method of claim 9, wherein the first partner relationship is confidential to the third vendor and the second partner relationship is confidential to the first vendor.

12. The method of claim 1, further comprising:
determining a type of partner relationship between the first vendor and the second vendor;
comparing the type of partner relationship to a set of authorized partner relationships; and
based on the comparing, authorizing the partner relationship when the type of partner relationship is among the set of authorized partner relationships.

13. The method of claim 1, further comprising:
determining a first vendor category for the first vendor;
determining a second vendor category for the second vendor; and
authorizing the partner relationship based on the determined first vendor category and the second vendor category.

14. A computer system that comprises:
one or more computer-readable storage media; and
one or more processors coupled to the one or more computer-readable storage media, execution by the one or more processors of instructions stored on the one or more computer-readable storage media causing the computer system to:
receive a request from a first computing device associated with a first vendor to establish a relationship with a second vendor;
generate a unique relationship key associated with the second vendor;
receive one or more signals comprising information relating to a copy of the unique relationship key from the first computing device associated with the first vendor; and
based on receiving the copy of the unique relationship key, establish the relationship between the first vendor and the second vendor.

15. The computer system of claim 14, wherein instructions stored on the one or more computer-readable storage media further cause the computer system to:
send one or more signals comprising the unique relationship key to a second computing device associated with the second vendor.

16. The computer system of claim 14, wherein instructions stored on the one or more computer-readable storage media further cause the computer system to:
receive a relationship key request from a second computing device associated with the second vendor, wherein generating the unique relationship key is in response to the relationship key request.

17. The computer system of claim 14, wherein instructions stored on the one or more computer-readable storage media further cause the computer system to:
receiving a reset request from a second computing device associated with the second vendor; and
responsive to receiving the reset request, resetting the unique relationship key from a first value to a second value, wherein the second value is different from the first value.

18. A computer program product that comprises one or more computer-readable storage media that store instructions that, when executed by one or more processors, cause a computer system to:
receive a request from a computing device associated with a first vendor to establish a relationship with a second vendor;
generate a unique relationship key associated with the second vendor;
receive one or more signals comprising information relating to a copy of the unique relationship key from the computing device associated with the first vendor; and
based on receiving the copy of the unique relationship key, establish the relationship between the first vendor and the second vendor.

19. The computer program product of claim 18, wherein instructions stored on the one or more computer-readable storage media further cause the computer system to:
send one or more signals comprising the unique relationship key to a second computing device associated with the second vendor.

20. The computer program product of claim 18, wherein instructions stored on the one or more computer-readable storage media further cause the computer system to:
receive a relationship key request from a second computing device associated with the second vendor, wherein generating the unique relationship key is in response to the relationship key request.
